(19) United States
(12) Patent Application Publication
(10) Pub. No.: US 2026/0322059 A1
(43) Pub. Date: Oct. 15, 2026

(54) FIBER-BASED OPTICAL SELF-REFERENCING INTERFEROMETRY

(71) Applicant: TOPTICA Photonics SE, Gräfelfing (DE)

(72) Inventors: Sana BOUGHDACHI, München (DE); Rafal WILK, München (DE); Andreas BRODSCHELM, München (DE)

(73) Assignee: TOPTICA Photonics SE, Gräfelfing (DE)

(21) Appl. No.: 19/645,472

(22) Filed: Apr. 13, 2026

(30) Foreign Application Priority Data
Apr. 11, 2025 (DE) 10 2025 114 398.6

(51) Int. Cl. H01S 3/067; G02F 1/355; H01S 3/137

(52) U.S. Cl. CPC H01S 3/06712; G02F 1/3558; H01S 3/06725; H01S 3/137

(57) ABSTRACT

The disclosure relates to a method for optical self-referencing interferometry. The objective of the disclosure is to provide a fiber-optic method and a fiber-based device for self-referencing interferometry that can be implemented cost-effectively and ensure high mechanical stability, reproducibility, and the ability to be integrated into existing frequency comb systems. For this, the disclosure proposes a method comprising the following steps: generation of pulsed laser radiation, whose spectrum is an optical frequency comb and comprises at least one octave, wherein the spectrum contains a first component at a first wavelength λ₁ and a second component at a second wavelength λ₂ with λ₂=2λ₁; guiding the laser radiation through a first section of a polarization-maintaining optical fiber with a polarization direction aligned along a first principal axis of the optical fiber; wavelength-selective polarization rotation of only one of the two components, for example the second component, by 90°, so that it is subsequently guided through the first section with a polarization direction aligned along a second principal axis of the optical fiber; polarization-selective frequency doubling of only the second component in a nonlinear medium; interfering superposition of the first component and the frequency-doubled second component for generation of a beat signal on a detector. Furthermore, the disclosure relates to a device for carrying out the method.

### RELATED APPLICATION(S)

This application claims the benefit of priority of German Patent Application No. 10 2025 114 398.6 filed Apr. 11, 2025, the contents of which are incorporated by reference as if fully set forth herein in their entirety.

### FIELD AND BACKGROUND OF THE INVENTION

The disclosure relates to a method and a device for optical self-referencing interferometry, for example for measuring and stabilizing the carrier envelope frequency (CEO frequency) of an optical frequency comb.

The determination of the CEO frequency is a fundamental prerequisite for the complete characterization of an optical frequency comb, as it makes it possible to specify each individual spectral line of the comb in absolute frequency values. Optical frequency combs are typically generated by mode-locked femtosecond lasers and have wide-ranging applications in frequency metrology, optical frequency synthesis and high-resolution spectroscopy.

The classic method for measuring the CEO frequency is based on a so-called f-2f interferometer, in which a spectral component of a frequency comb with a wavelength λ₂ is frequency-doubled and interferes with a component already present in the original spectrum at half the wavelength λ₁ with λ₂=2λ₁. The resulting beat signal corresponds directly to the CEO frequency and can be used to actively stabilize the frequency comb. To be more precise, the beat signal has the frequency f_{CEO}=2(f_{CEO}+fₙ)−(f_{CEO}+2*fₙ), where f_{CEO} is the CEO frequency and fₙ+f_{CEO} is the frequency of the spectral line of the frequency comb with index n. The first term 2(f_{CEO}+fₙ) represents the frequency doubling of this line. The second term indicates the frequency of the non-frequency-doubled line originally contained in the spectrum at (f_{CEO}+2*fₙ). In conventional systems, this interferometry is usually realized by free-beam optical components that include optical beam splitters, non-linear crystals for frequency doubling and adjustable delay elements. These setups require precise opto-mechanical adjustments and are susceptible to environmental influences such as mechanical vibrations or temperature fluctuations.

Recent developments have shown that the implementation of an f−2f interferometer in integrated optical systems on semiconductor or lithium niobate platforms can lead to a significant reduction in system complexity. It has already been demonstrated that frequency comb self-referencing can be realized by a combination of supercontinuum generation and frequency doubling in integrated nonlinear waveguides. However, a key challenge is to provide a compact, stabilized and broadband-adaptable solution that operates at low pulse energy and does not require complex alignment. For example, the state of the art according to Okawachi et al. (Optica, Vol. 7, No. 6, June 2020, p. 702) describes that in integrated lithium niobate waveguides, both frequency doubling and supercontinuum generation can take place within the same waveguide. This enables efficient CEO frequency measurement with low pulse energies and a large spectral bandwidth. However, the integrated optical systems required are technologically complex to manufacture and correspondingly expensive.

Sinclair et al. (“Operation of an optically coherent frequency comb outside the metrology lab”, Optics Express 22, 6996-7006, 2014) describe a self-referenced fiber-based frequency comb that can be used for precise metrological measurements outside the controlled laboratory environment. Here, the frequency comb is based on a fully polarization-preserving fiber-optic setup with amplified femtosecond Er fiber comb, spectral broadening in a highly nonlinear fiber, and frequency doubling in a waveguide-based periodically poled lithium niobate crystal (PPLN) for f−2f self-referencing. The CEO frequency is detected according to the principle of superposition of the frequency-doubled long-wavelength comb component with the short-wavelength component, wherein an “in-line” interferometer of polarization-maintaining fibers for propagation time compensation and superposition is used. The system is characterized by high stability, robustness against vibrations and complete encapsulation of all fiber optic components, enabling operation even under ambient conditions outside the laboratory or on mobile platforms. The known setup requires specially tailored components and precise fiber integration, for example to generate the temporal superposition of the relevant comb components after frequency doubling, and is comparatively complex to implement.

### SUMMARY OF THE INVENTION

The disclosure provides a method for optical self-referencing interferometry, comprising the following steps:
generation of pulsed laser radiation whose spectrum is an optical frequency comb and comprises at least one octave, wherein the spectrum contains a first component at a first wavelength λ₁ and a second component at a second wavelength λ₂ with λ₂=2λ₁,
guiding the laser radiation through a first portion of a polarization-maintaining optical fiber having a polarization direction aligned along a first principal axis of the optical fiber,
wavelength-selective polarization rotation of only one of the two components, for example the second component, by 90°, so that it is subsequently guided through the first section with the polarization direction aligned along a second principal axis of the optical fiber,
polarization-selective frequency doubling of only the second component in a non-linear medium, and
interfering superposition of the first component and the frequency-doubled second component for generation of a beat signal on a detector.

### BRIEF DESCRIPTION OF THE SEVERAL VIEWS OF THE DRAWING(S)

An embodiment example of the disclosure is explained in more detail with reference to the drawing:

FIG. 1 shows a block diagram of a device according to the disclosure.

### DESCRIPTION OF SPECIFIC EMBODIMENTS OF THE INVENTION

The disclosure provides a method for optical self-referencing interferometry, comprising the following steps:
generation of pulsed laser radiation whose spectrum is an optical frequency comb and comprises at least one octave, wherein the spectrum contains a first component at a first wavelength λ₁ and a second component at a second wavelength λ₂ with λ₂=2λ₁,
guiding the laser radiation through a first portion of a polarization-maintaining optical fiber having a polarization direction aligned along a first principal axis of the optical fiber,
wavelength-selective polarization rotation of only one of the two components, for example the second component, by 90°, so that it is subsequently guided through the first section with the polarization direction aligned along a second principal axis of the optical fiber,
polarization-selective frequency doubling of only the second component in a non-linear medium, and
interfering superposition of the first component and the frequency-doubled second component for generation of a beat signal on a detector.

In contrast to integrated waveguide solutions, the disclosure exploits the properties of polarization-maintaining optical fibers to enable selective frequency doubling of the long-wavelength spectral component of the optical frequency comb without complex alignment

The disclosure provides the selective use of a polarization-maintaining optical fiber to selectively rotate the polarization direction of only one of the two spectral components, for example the second component, in combination with efficient frequency doubling by exploiting the polarization selectivity of the nonlinear medium used for frequency doubling. The first component and the second component are passed together through the same optical fiber and the nonlinear medium and can be made to interfere with each other after the selective frequency doubling of only the second component in order to extract the CEO frequency from the resulting beat signal.

A wavelength-selective polarization rotation is implemented in order to ensure that only one specific spectral component, for example the second component, is present in the polarization direction suitable for the non-linear frequency conversion. As a result, a frequency-doubled second component propagates in an optical fiber following the nonlinear medium, which is subsequently brought to interfere with the first component already present in the original spectrum and passed through the same fiber

This implementation of self-referencing interferometry results in a compact, robust and cost-efficient f−2f interferometer that does not require any free-beam optical components or integrated optics. The method is scalable for different wavelength ranges. The disclosure thus represents a technological improvement over existing methods and enables simplified integration into industrial and scientific applications.

In one possible embodiment, the wavelength-selective polarization rotation is performed by at least two 45° splices in the first section of the polarization-maintaining optical fiber. This embodiment uses the birefringence of the fiber to specifically influence the polarization direction of the spectral components. This approach allows separation and targeted rotation of the polarization modes for the two different wavelengths, which ensures efficient selective frequency doubling of only the second component in the subsequent non-linear process

A 45° splice refers to a splice connection (fusion splice) between two subsections of the polarization-maintaining fiber, in which the principal optical axes of the second subsection are rotated by 45° relative to the first subsection. If a linearly polarized light field is coupled into the first subsection along the first principal axis, the field is split along both principal axes after the splice with identical intensities, but with different phase velocities. Due to the birefringence of the fiber, a wavelength-dependent phase shift between these modes accumulates over the distance. If a second splice rotated by −45° is inserted after a certain fiber distance, the polarization modes are transferred back to the original polarization system. Essential is here that the accumulated phase shift is wavelength-dependent due to the propagation time difference of the modes. By selecting the appropriate fiber distance between the splices, a phase shift of 180° (π phase shift) can be achieved for the second component at the second, longer wavelength λ₂. For the second wavelength, the two correspondingly spaced-apart 45° splices thus act like a half-wave plate. For the first wavelength λ₁, which is half as long as λ₂, the arrangement of the two 45° splices acts like a “full wave plate”, which causes a phase shift of 360° and thus leaves the polarization of the first component unchanged. The result is a wavelength-selective polarization rotation in which the polarization of the long-wave component at λ₂ is rotated by 90°, while the polarization of the short-wave component λ₁ retains its original direction. The two components then propagate independently of each other with polarization aligned along the respective principal axis of the optical fiber.

It should be noted that due to the dispersion of the optical fiber, the phase shift at the position of the second 45° splice is not exactly equal to 180°. This can lead to a certain proportion of the second component of the laser radiation propagating through the first section after the second 45° splice with the polarization direction aligned along the “wrong” main axis of the optical fiber. However, this has no relevant effect in the method of the disclosure and can therefore be ignored.

In a further possible embodiment, the laser radiation is guided through a second section of the polarization-maintaining optical fiber after passing through the non-linear medium, wherein the interfering superposition of the first component and the frequency-doubled second component takes place by means of a 45° splice in the second section. The guidance of the laser radiation through the second section after the non-linear frequency doubling and the interfering superposition of the first component and the frequency-doubled second component by means of the 45° splice in this section is an efficient method for generating the desired interference signal. This configuration again uses the birefringence of the fiber to superimpose the two previously separately propagating spectral components in a targeted manner, whereby a robust and fiber-based realization of self-referencing interferometry is enabled.

After frequency doubling in the nonlinear medium, the original short-wavelength first component and the frequency-doubled second component propagate in orthogonal polarization modes of the polarization-maintaining fiber in its second section. The 45° splice again leads to a uniform mode splitting, whereby a superposition of both components is generated in both principal axes of the sub-section of the polarization-maintaining fiber following the splice . This causes the two components to interfere and the beat signal required for self-referencing interferometry, the frequency of which corresponds directly to the CEO frequency of the optical frequency comb, can be generated and recorded by means of a detector.

In a further possible embodiment, the second section is designed with regard to the respectively group velocity dispersion assigned to the principal axes and the positioning of the 45° splice within the second section in such a way that propagation time differences are compensated so that the first component and the frequency-doubled second component coincide in time at the position of the 45° splice. Design with regard to group velocity dispersion and positioning of the 45° splice refers for example to the targeted positioning of the 45° splice in accordance with the (given) dispersion properties (group velocity dispersion) of the optical fibers.

The corresponding design of the second section of the polarization-maintaining optical fiber enables an exact temporal coincidence of the original first component and the frequency-doubled second component at the interference point. This ensures that the spectral components of interest interfere and a stable beat signal is generated for the determination of the CEO frequency.

After frequency doubling in the non-linear medium, the short-wave first component continues to propagate with its original polarization direction, while the polarization direction of the long-wave second component in the first section of the polarization-maintaining fiber has been rotated by 90°. The second component continues to have this polarization direction after the frequency doubling. Since the two components therefore propagate in different polarization modes, they are subject to different group velocities. As a result, a wavelength-dependent propagation time difference builds up between them. This propagation time difference prevents the required interference and must therefore be compensated for. In order to achieve this, the second section of the polarization-maintaining fiber is suitably designed so that the propagation time differences are compensated for by the group velocity dispersion of the fiber axes. This can be achieved for example by selecting a suitable fiber length and by selectively coupling the laser radiation into the second section after it has passed through the non-linear medium, so that the polarization directions of the two components are aligned along the first and second principal axes in such a way that the first component and the frequency-doubled second component converge in time in the second section due to the respectively different group velocity dispersion assigned to the principal axes until they coincide in time at the position of the 45° splice.

This embodiment provides that maximum temporal overlap of the two components is achieved by the propagation time compensation, whereby the resulting beat signal can be optimally detected. This eliminates the need for additional delay lines or active compensation mechanisms, making the optical setup compact and less prone to errors. The second section only needs to be suitably designed once. The interfering superposition of the components then functions without further adjustment. Finally, the approach described allows a completely fiber-based and therefore robust and cost-effective implementation.

It should be noted that the above specification “45° splice” is not to be understood as a splice with an angular offset of exactly 45°. Deviations from 45° are possible. If the field amplitudes of the components propagating separately up to the splice point, with their polarization directions along the two principal axes, are the same, 45° is ideal.

In another possible embodiment, the CEO frequency of the optical frequency comb is extracted from the beat signal generated by the interfering superposition of the first component and the frequency-doubled second component. The extracted CEO frequency can be used to actively stabilize the optical frequency comb by implementing a feedback loop that controls a suitable control element of a laser used to generate the frequency comb.

The disclosure further solves the above task by a device for optical self-referencing interferometry.

The device is designed in such a way that it enables a fully fiber-based implementation of an f−2f interferometer, thereby providing a robust and compact alternative to free-beam optical setups.

The device comprises a first section of a polarization-maintaining optical fiber, which is used to guide the laser radiation. This has a spectrum that spans at least one octave and comprises a first component with a wavelength λ₁ and a second component with a wavelength λ₂, where λ₂=2λ₁. In order to enable frequency-selective frequency doubling, a wavelength-selective polarization rotator is provided. This is designed so that the polarization direction of one of the two components remains unchanged, while the polarization direction of the other component is rotated by 90°. This causes a targeted separation of the spectral components along the orthogonal principal axes of the fiber. After the polarization rotation, the laser radiation is coupled into a non-linear optical medium that performs polarization-selective frequency doubling. Hereby the second component is doubled in frequency, while the first component passes through the medium unchanged. In this way, a new spectral component is created, which emerges from the original second component due to the non-linear interaction. The device further comprises a superposition device designed to cause the original first component and the frequency-doubled second component to interfere. A detector is provided, which detects the resulting beat signal. This contains the CEO frequency of the optical frequency comb.

The device enables precise and stable detection of the CEO frequency. Due to the complete fiber optic implementation, the device offers high mechanical stability and robustness compared to conventional systems with free beam optical components. The use of polarization-maintaining optical fibers ensures precise control of the mode guidance and is adjustment-free. This provides a compact and easily integrated solution for the self-referencing of optical frequency combs.

In an embodiment of the device, the wavelength-selective polarization rotator is realized by two 45° splices arranged at a defined distance in the first section of the polarization-maintaining optical fiber. This arrangement uses the intrinsic birefringence of the fiber to effect a targeted, wavelength-selective polarization rotation, as described above. The polarization rotation is intrinsically wavelength-selective, so that no additional filter or separating elements are required. This results in a simple design with high robustness.

In a further embodiment of the device, the nonlinear optical medium is formed as a periodically poled lithium niobate crystal (PPLN), which is directly fiber-coupled to the first section of the polarization-maintaining optical fiber. Suitable fiber-coupled PPLN crystals are commercially available. The PPLN crystal enables efficient frequency doubling through a X(2) process. The disclosure exploits the fact that the PPLN crystal only frequency-doubles laser radiation of a specific polarization direction. This is specifically exploited by adjusting the polarization of the second spectral components before the nonlinear interaction in the first section of the polarization-maintaining optical fiber by the wavelength-selective polarization rotator. For example, the first component with wavelength λ₁ remains in its original polarization direction, while the second component with wavelength λ₂ is converted to the polarization suitable for the non-linear conversion by a targeted polarization rotation of 90°. This arrangement ensures that only the second component is frequency-doubled while the first component passes through the non-linear medium unchanged. After the frequency conversion, a new spectral component is created, which emerges from the original second component as a result of the non-linear process and can interfere with the first component already present in the original spectrum.

In another possible embodiment, the device has a femtosecond laser that generates the laser radiation and a section of a highly nonlinear fiber that is used to spectrally broaden the laser radiation so that its spectrum covers at least one octave. The femtosecond laser is for example a mode-locked fiber laser that generates short laser pulses with a pulse duration in the femtosecond range. The spectral bandwidth of the radiation emitted directly from the laser is typically limited, so that spectral broadening is required for self-referencing interferometry. To generate a sufficiently broad spectrum, the laser radiation is guided through a section of a highly nonlinear fiber in which a strong spectral broadening is achieved by supercontinuum generation.

In one possible embodiment, the superimposing device has a second section, which is fiber-coupled to the non-linear optical medium, of the polarization-maintaining optical fiber with a 45° splice. With regard to the respectively group velocity dispersion assigned to each of the principal axes and the positioning of the 45° splice, the second section is designed to compensate for propagation time differences so that the first component and the frequency-doubled second component coincide in time at the position of the 45° splice. Since, as described above, the two components propagate in orthogonal polarization modes after the non-linear frequency doubling, they are subject to different group velocities, resulting in a time delay. This delay is compensated for by the dispersion properties of the second fiber section, so that the two components coincide in time at the position of the 45° splice. The 45° splice causes an interfering superposition of the two components, resulting in the beat signal. This completely fiber-based, alignment-free solution ensures a temporal coincidence of the spectral components as a prerequisite for the interference and thus for the extraction of the CEO frequency.

In another possible embodiment, the detector is designed as a photodiode that detects the beat signal as a high-frequency electrical signal. The photodiode converts the interfering optical superposition of the first component and the frequency-doubled second component into an electrical signal whose frequency corresponds to the CEO frequency of the optical frequency comb. The detected signal can be used subsequently for further electronic processing and stabilization of the frequency comb. The fiber-optic coupling of the photodiode to the second section of the polarization-maintaining optical fiber (behind the 45° splice) ensures low-loss and robust signal detection, making the system mechanically stable and easy to integrate. The photodiode is for example designed for high bandwidths and/or high dynamics, depending on whether the CEO frequency is only to be measured or also used to stabilize the frequency comb.

In another possible embodiment, the device has a bandpass filter that is arranged downstream of the non-linear optical medium in the path of the laser radiation and serves to suppress undesired spectral components. The spectral passband width of the band-pass filter is essentially the same as the conversion bandwidth of the non-linear optical medium, so that only the relevant spectral components for the interfering superposition and the CEO frequency detection are retained. This targeted filtering improves the signal-to-noise ratio of the detection while minimizing unwanted spectral contributions. The bandpass filter can be integrated into the second section together with a blocking element that specifically blocks the laser radiation propagating in the direction of polarization along one of the two main axes directly in front of the detector. The integration of the bandpass filter (and the blocking element) after frequency doubling ensures precise spectral selection within the fiber optic setup without impairing the efficiency of the beat signal detection.

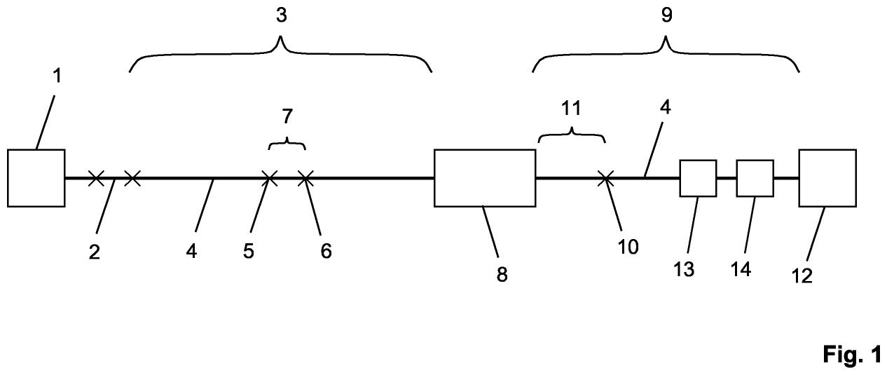

In the following, an embodiment example of the disclosure is explained in more detail with reference to the drawing. It shows:
FIG. 1 Block diagram of a device according to the disclosure.

In the following description of the figure, the same reference signs and the same terms are used for the same elements.

The disclosure is described below with reference to the schematic block diagram of a device for optical self-referencing interferometry shown in FIG. 1.

In FIG. 1, X-shaped crosses indicate splice connections between sections of optical fibers.

The device comprises a femtosecond fiber laser 1, which generates laser radiation whose spectrum is an optical frequency comb. The laser radiation is coupled into a section of a highly nonlinear fiber 2, in which a spectral broadening takes place so that the spectrum of the laser radiation comprises at least one octave. Thereby the spectrum contains a first component at a first wavelength λ₁ and a second component at a second wavelength λ₂ with λ₂=2λ₁.

The broadband laser radiation generated in this way is coupled into a first section 3 of a polarization-maintaining optical fiber 4. This contains a wavelength-selective polarization rotator, which is formed by two spaced-apart 45° splices 5, 6 with a fiber section 7 between them. A 45° splice refers to a splice connection between two subsections of the polarization-maintaining fiber 4, in which the principal optical axes of the second subsection are rotated by 45° relative to the first subsection. In the embodiment example, the relative rotation is 45° for the first splice 5 and −45° for the second splice 6. By appropriately selecting the length of the fiber section 7 between the splices 5, 6, a phase shift of 180°is achieved for the second component at the second, longer wavelength λ₂.

For the second wavelength, the two correspondingly spaced-apart 45° splices thus act like a half-wave plate. For the first wavelength λ₁, which is half as long as λ₂, the arrangement of the two 45° splices 5, 6 produces a phase shift of 360° and thus leaves the polarization of the first component unchanged. As a result, the two 45° splices 5, 6 produce a wavelength-selective polarization rotation in which the polarization of the long-wavelength component at λ₂ is rotated by 90°, while the polarization of the short-wavelength component λ₁ retains its original direction

After the polarization rotation, the laser radiation is coupled into a non-linear optical medium 8, which is formed as a fiber-coupled, periodically poled lithium niobate crystal (PPLN). A waveguide made of periodically poled lithium niobate (PPLN waveguide) is also suitable. Due to the polarization-selective non-linear interaction, only the frequency of the second component is doubled in the PPLN crystal 8, while the first component passes through the PPLN crystal 8 unchanged.

The laser radiation modified in this way passes into a second section 9, coupled to the PPLN crystal 8, of the polarization-maintaining optical fiber 4, in which a superimposing device is provided. This comprises a further 45° splice 10, which superimposes the first component and the frequency-doubled second component in an interfering manner. The 45° splice 10 is arranged at a certain fiber distance 11 from the PPLN crystal 8. The fiber distance 11, that is the position of the 45° splice 10 in the second section 9, is selected such that, due to the respectively group velocity dispersion assigned to the principal axes of the polarization-maintaining fiber 4, propagation time differences between the two components are compensated for and thus the first component and the in the PPLN crystal 8 frequency-doubled second component can coincide in time at the position of the 45° splice 10 and interfere with each other.

The beat signal resulting from the interference is detected by a fiber-coupled photodiode 12, which converts the optical signal into a high-frequency electrical signal. To improve the signal-to-noise ratio, a bandpass filter 13 can be provided whose passband width is adapted to the conversion bandwidth of the non-linear medium in order to suppress unwanted spectral contributions. A blocking element 14 can be connected downstream of the bandpass filter 13, which specifically blocks one of the two polarization directions upstream of the photodiode 12.

The electrical signal output from the photodiode 12 can be fed to a downstream electronic processing unit (not shown) in order to extract the CEO frequency and enable active stabilization of the optical frequency comb by feedback to the femtosecond laser 1.

The disclosure provides a fiber-optic method and a fiber-based device for self-referencing interferometry, which can be implemented at low cost, guarantee a high mechanical stability, reproducibility and integration capability in existing frequency comb systems.

Additional Examples are now described.
Example 1 is a method for optical self-referencing interferometry, comprising the following steps:
   generation of pulsed laser radiation whose spectrum is an optical frequency comb and comprises at least one octave, wherein the spectrum contains a first component at a first wavelength λ₁ and a second component at a second wavelength λ₂ with λ₂=2λ₁,
   guiding the laser radiation through a first section (3) of a polarization-maintaining optical fiber (4) with a polarization direction aligned along a first principal axis of the optical fiber (4),
   wavelength-selective polarization rotation of only one of the two components, for example the second component, by 90°, so that it is subsequently guided through the first section (3) with a polarization direction aligned along a second principal axis of the optical fiber (4),
   polarization-selective frequency doubling of only the second component in a non-linear medium (8), and
   interfering superposition of the first component and the frequency-doubled second component for generation of a beat signal on a detector (12).
In Example 2, the method of Example 1 may optionally include, wherein the wavelength-selective polarization rotation is performed by at least two 45° splices (5, 6) in the first section (3) of the polarization-maintaining optical fiber (4).
In Example 3, the method of any one of Examples 1-2 may optionally include, wherein the laser radiation, after passing through the nonlinear medium (8), is guided through a second section (9) of the polarization-maintaining optical fiber (4), wherein the interfering superposition of the first component and the frequency-doubled second component is effected by a 45° splice (10) in the second section (9).
In Example 4, the method of Example 3 may optionally include, wherein the second section (9) is designed with respect to the respectively group velocity dispersion assigned to the principal axes of the second section (9) and the positioning of the 45° splice (10) in the second section (9) in such a way that propagation time differences are compensated so that the first component and the frequency-doubled second component coincide in time at the position of the 45° splice (10) in the second section (9).
In Example 5, the method of any one of Examples 1-4 may optionally include, wherein a carrier envelope frequency of the optical frequency comb is extracted from the beat signal and is used for stabilization of the optical frequency comb.
Example 6 is a device for optical self-referencing interferometry, comprising:
   a first section (3) of a polarization-maintaining optical fiber (4) with a wavelength-selective polarization rotator, intended to rotate the polarization direction of a first component at a first wavelength λ₁ or of a second component at a second wavelength λ₂, with λ₂=2λ₁, of a laser beam guided through the first section by 90° and to leave the polarization direction of the other component unchanged;
   a non-linear optical medium (8) intended to effect a polarization-selective frequency doubling of only the second component and to allow the first component to pass with unchanged wavelength,
   a superimposing device intended to superimpose the first component and the frequency-doubled second component in an interfering manner, and
   a detector (12) provided for detecting a beat signal of the interfering components.
In Example 7, the device of Example 6 may optionally include, wherein the wavelength-selective polarization rotator is formed by two spaced-apart 45° splices (5, 6) in the first section (3) of the polarization-maintaining optical fiber (4).
In Example 8, the device of any one of Examples 6-7 may optionally include, wherein the non-linear optical medium (8) is a periodically poled lithium niobate crystal (PPLN) coupled to the first portion (3) of the polarization-maintaining optical fiber (4).
In Example 9, the device of any one of Examples 6-8 may optionally further comprise a femtosecond laser (1), which generates the laser radiation, and a portion of a highly nonlinear fiber (2) for spectrally broadening the laser radiation so that its spectrum comprises at least one octave.
In Example 10, the device of any one of Examples 6-9 may optionally include, wherein the superimposing device comprises a second portion (9) of the polarization-maintaining optical fiber (4) coupled to the non-linear optical medium (8) and having a 45° splice (10).
In Example 11, the device of Example 10 may optionally in include, wherein the second section (9) is designed to equalize propagation time differences with respect to the respectively group velocity dispersion associated with the principal axes of the second section (9) and the positioning of the 45° splice (10) in the second section (9), so that the first component and the frequency-doubled second component coincide in time at the position of the 45° splice (10) in the second section.
In Example 12, the device of any one of Examples 6-11 may optionally include, wherein the detector (12) is a photodiode that detects the beat signal as a high-frequency electrical signal.
In Example 13, the device of any one of Examples 6-12 may optionally comprise a bandpass filter (13) following the nonlinear optical medium (8) in the course of the laser radiation, provided to suppress undesired spectral components of the laser radiation, wherein the spectral passband width of the bandpass filter (13) is substantially equal to the conversion bandwidth of the nonlinear optical medium (8).
In Example 14, the device of Example 13 may optionally include a blocking element (14) connected upstream of the detector (12) in the path of the laser radiation, provided for blocking the laser radiation propagating with polarization direction along one of the two main axes of the second section (9) upstream of the detector (12).

What is claimed is:

1. A method for optical self-referencing interferometry, comprising the following steps:
generation of pulsed laser radiation whose spectrum is an optical frequency comb and comprises at least one octave, wherein the spectrum contains a first component at a first wavelength λ₁ and a second component at a second wavelength λ₂ with λ₂=2λ₁,
guiding the laser radiation through a first section of a polarization-maintaining optical fiber with a polarization direction aligned along a first principal axis of the optical fiber,
wavelength-selective polarization rotation of only one of the two components, for example the second component, by 90°, so that it is subsequently guided through the first section with a polarization direction aligned along a second principal axis of the optical fiber,
polarization-selective frequency doubling of only the second component in a non-linear medium, and
interfering superposition of the first component and the frequency-doubled second component for generation of a beat signal on a detector.

2. The method according to claim 1, wherein the wavelength-selective polarization rotation is performed by at least two 45° splices in the first section of the polarization-maintaining optical fiber.

3. The method according to claim 1, wherein the laser radiation, after passing through the nonlinear medium, is guided through a second section of the polarization-maintaining optical fiber, wherein the interfering superposition of the first component and the frequency-doubled second component is effected by a 45° splice in the second section.

4. The method according to claim 3, wherein the second section is designed with respect to the respectively group velocity dispersion assigned to the principal axes of the second section and the positioning of the 45° splice in the second section in such a way that propagation time differences are compensated so that the first component and the frequency-doubled second component coincide in time at the position of the 45° splice in the second section.

5. The method according to claim 1, wherein a carrier envelope frequency of the optical frequency comb is extracted from the beat signal and is used for stabilization of the optical frequency comb.

6. A device for optical self-referencing interferometry, comprising:
a first section of a polarization-maintaining optical fiber with a wavelength-selective polarization rotator, intended to rotate the polarization direction of a first component at a first wavelength λ₁ or of a second component at a second wavelength λ₂, with λ₂=2λ₁, of a laser beam guided through the first section by 90° and to leave the polarization direction of the other component unchanged;
a non-linear optical medium intended to effect a polarization-selective frequency doubling of only the second component and to allow the first component to pass with unchanged wavelength,
a superimposing device intended to superimpose the first component and the frequency-doubled second component in an interfering manner, and
a detector provided for detecting a beat signal of the interfering components.

7. The device according to claim 6, wherein the wavelength-selective polarization rotator is formed by two spaced-apart 45° splices in the first section of the polarization-maintaining optical fiber.

8. The device according to claim 6, wherein the non-linear optical medium is a periodically poled lithium niobate crystal (PPLN) coupled to the first portion of the polarization-maintaining optical fiber.

9. The device according to claim 6, further comprising a femtosecond laser, which generates the laser radiation, and a portion of a highly non-linear fiber for spectrally broadening the laser radiation so that its spectrum comprises at least one octave.

10. The device according to claim 6, wherein the superimposing device comprises a second portion of the polarization-maintaining optical fiber coupled to the non-linear optical medium and having a 45° splice.

11. The device according to claim 10, wherein the second section is designed to equalize propagation time differences with respect to the respectively group velocity dispersion associated with the principal axes of the second section and the positioning of the 45° splice in the second section, so that the first component and the frequency-doubled second component coincide in time at the position of the 45° splice in the second section.

12. The device according to claim 6, wherein the detector is a photodiode that detects the beat signal as a high-frequency electrical signal.

13. The device according to claim 6, comprising a bandpass filter following the nonlinear optical medium in the course of the laser radiation, provided to suppress undesired spectral components of the laser radiation, wherein the spectral passband width of the bandpass filter is substantially equal to the conversion bandwidth of the nonlinear optical medium.

14. The device according to claim 13, with a blocking element connected upstream of the detector in the path of the laser radiation, provided for blocking the laser radiation propagating with polarization direction along one of the two main axes of the second section upstream of the detector.
